(19) United States
(12) Patent Application Publication
(10) Pub. No.: US 2003/0205905 A1
(43) Pub. Date: Nov. 6, 2003

(54) Wafer holder

(75) Inventors: Chih-Kun Chen, Taoyuan Hsien (TW); Shan-Chang Wang, Taoyuan Hsien (TW); Jiun-Bo Wang, Taipei (TW); Chia-Chung Yin, Taoyuan (TW)

Correspondence Address: Quintero Law Office, 1617 Broadway, 3rd Floor, Santa Monica, CA, 90404, US

(73) Assignee: Nanya Technology Corporation

(21) Appl. No.: 10/385,024

(22) Filed: Mar. 10, 2003

(30) Foreign Application Priority Data
May 3, 2002 (TW) 91206222

(51) Int. Cl. B25J 13/08

(52) U.S. Cl. 294/1.1; 294/907; 901/47

(57) ABSTRACT

A wafer holder in a robot blade. A holder plate having a front end is provided. At least one sensor is disposed at the front end of the holder plate. A sensing circuit is connected to the sensor, wherein the sensing circuit determines the presence or absence of an obstruction positioned immediately ahead of the holder plate. Thus, the wafer holder is capable of avoiding contact with obstructions, thereby preventing system crash during semiconductor manufacturing process.

### BACKGROUND OF THE INVENTION

1. Field of the Invention

The present invention relates to a wafer holder for transporting wafers into and out of semiconductor processing equipment, and more particularly, to a wafer holder capable of preventing system crash during semiconductor manufacturing process.

2. Description of the Related Art

In fabrication processes for semiconductor devices, a semiconductor wafer is normally processed through many different fabrication steps, sometimes as many as several hundred. These processing steps may include deposition, etching, ion implantation, and a variety of other processes. The fabrication equipment utilized in these processes may include process chambers that are arranged in a cluster formation with a central loadlock chamber to deliver and withdrawing wafers to and from each process chamber.

One of the key components in a loadlock chamber is a wafer blade normally controlled by a robotic arm. The wafer blade is also called a robot blade by some equipment manufacturers. The robot blade can be constructed of a thin piece of metal such that it holds a wafer securely to deliver it into process chambers through narrow slit valves provided in the sides of the process chambers that join the loadlock chamber.

A typical robot blade 100 is shown in FIG. 1. The robot blade 100 is constructed mainly of a robot arm 110 and a wafer holder 120 (also called a wafer holding hand). The wafer holder 120 has a small thickness so that it may go through narrow slit valves to deliver or withdraw wafers to and from a process chamber or a cassette indexer. FIG. 2 shows a sectional view of the wafer holder 120 holding a wafer 140 in a proper position. In the configuration shown in FIG. 2, the wafer 140 is carried at the tip portion of the wafer holder 120 on top of a vacuum port 130. A vacuum is supplied to the vacuum port 130 through a vacuum duct 131.

In the transporting process, when the cassette indexer is misplaced, the wafer in the cassette indexer is placed at a slant, or the robot blade is shifted in position, the wafer holder 120 collides with the cassette indexer, the wafer, or other obstructions. This may break the wafer or harm the wafer holder, seriously affecting the fabrication process.

To date, studies of the wafer holder have only addressed that the sensors are disposed on the holder for detecting whether a wafer is properly seated thereon. For example, in U.S. Pat. No. 6,113,165, Wen et al disclose a self-sensing wafer holder which includes a holder body for carrying a wafer on the top surface and at least three sensors positioned on the holder body, determining whether the wafer is properly seated on the top thereof. The wafer holder disclosed in U.S. Pat. No. 6,113,165 cannot, however, solve the problems mentioned.

### SUMMARY OF THE INVENTION

An object of the present invention is to provide a novel wafer holder.

Another object of the present invention is to provide a wafer holder having a system crash prevention function.

In order to achieve these objects, the present invention provides a wafer holder in a robot blade. A holder plate having a front end is provided. At least one sensor is disposed at the front end of the holder plate. A sensing circuit is connected to the sensor, wherein the sensing circuit determines the presence or absence of an obstruction positioned immediately ahead of the holder plate.

In order to achieve these objects, the present invention provides another wafer holder in a robot blade. A holder plate having a first extended finger and a second extended finger is provided, wherein the first finger has a first front end, and the second finger has a second front end. A first sensor is disposed at the first front end of the first finger. A second sensor is disposed at the second front end of the second finger. A sensing circuit is connected to the first sensor and the second sensor, wherein the sensing circuit determines the presence or absence of an obstruction positioned immediately ahead of the holder plate.

The present invention improves on the prior art in that the wafer holder of the present invention has at least one sensor disposed at the front end of the wafer holder. Thus, the present invention can prevent system crash during semiconductor manufacturing process, thereby preventing shutdown and ameliorating the disadvantages of the prior art.

### BRIEF DESCRIPTION OF THE DRAWINGS

The present invention can be more fully understood by reading the subsequent detailed description in conjunction with the examples and references made to the accompanying drawings, wherein:

FIG. 1 is a top view of a conventional robot blade having a wafer holder mounted thereon;

FIG. 2 is a partial, sectional view of a conventional wafer holder having a wafer held therein;

FIG. 3 is a top view showing a wafer holder of the present invention;

FIG. 4 is a top view showing another wafer holder of the present invention; and

FIG. 5 is a top view showing yet another other wafer holder of the present invention.

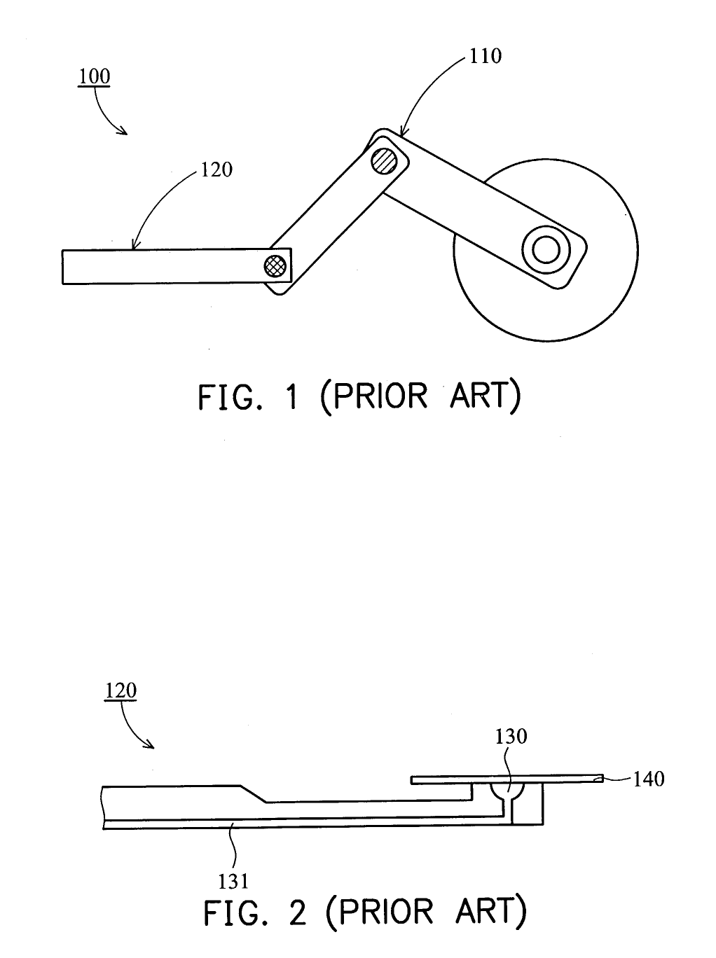

### DETAILED DESCRIPTION OF THE INVENTION

The First Embodiment

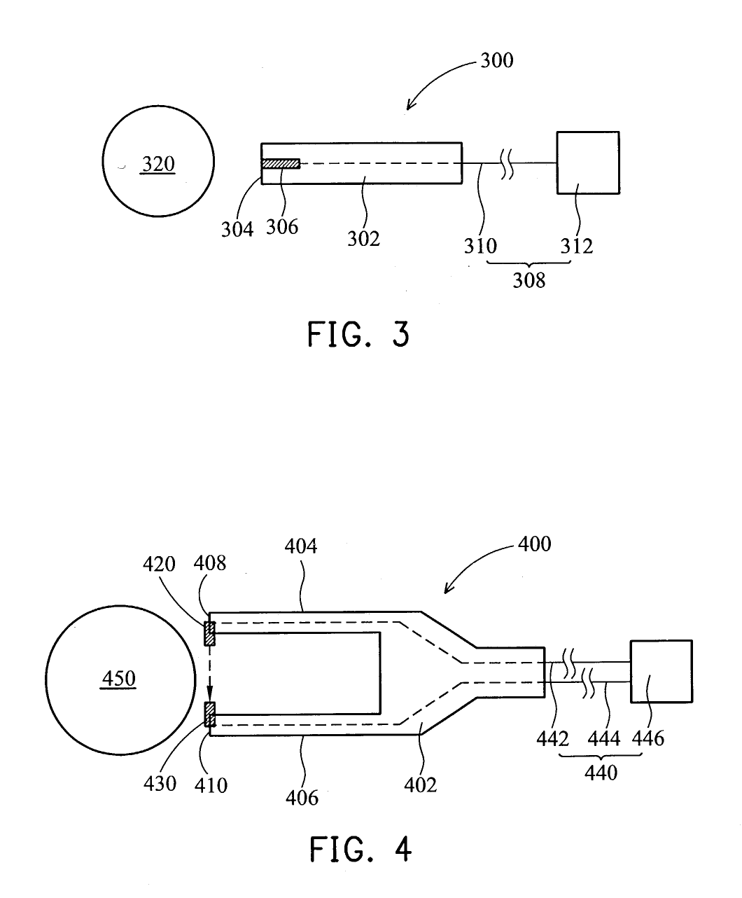

A wafer holder of the first embodiment is shown with reference to FIG. 3. FIG. 3 is a top view of the wafer holder according to the first embodiment of the present invention.

In FIG. 3, the wafer holder 300 in a robot blade assembly for transporting a wafer into and out of a process machine or a cassette indexer is provided. A holder plate 302 has a front end 304. The holder plate 302 can be constructed of a thin piece of metal.

In FIG. 3, at least one sensor 306 is disposed at the front end 304 of the holder plate 302. The sensor 306 can be an optical sensor, such as, for example, the optical fiber sensor Model: PS-48 made by KEYENCE.

In FIG. 3, a sensing circuit 308 is electrically connected to the sensor 306. The sensing circuit 308 determines the presence or absence of an obstruction 320, such as a wafer or a cassette indexer, positioned immediately ahead of the front end 304 of the holder plate 300. The sensing circuit 308 includes a signal line 310 and a controller 312. The signal line 310 transmits a signal from the sensor 306 to the controller 312. The controller 312 controls the motion of the wafer holder 300 according to the signal from the sensor 306. The controller 312 is adapted for outputting a signal to stop the motion of the wafer holder 300 when the obstruction 320 is detected by the sensor 306. In addition, the controller 312 can sound an alarm when the obstruction 320 is detected.

The Second Embodiment

A wafer holder of the second embodiment is shown with reference to FIG. 4. FIG. 4 is a top view of the wafer holder according to the second embodiment of the present invention.

In FIG. 4, the wafer holder 400 in a robot blade assembly for transporting a wafer into and out of a process machine or a cassette indexer is provided. A holder plate 402 has a first extended finger 404 and a second extended finger 406. That is, the holder plate 402 is a twin finger plate. The first finger 404 has a first front end 408, and the second finger 406 has a second front end 410. The holder plate 402 can be constructed of a thin piece of metal.

In FIG. 4, a first sensor 420 is disposed at the first front end 408 of the first finger 404. A second sensor 430 is disposed at the second front end 410 of the second finger 406. The sensors 420, 430 can be optical sensors. For example, the first sensor 420 can be a transmitter of an optical fiber sensor. The second sensor 430 is a receiver of an optical fiber sensor.

In FIG. 4, a sensing circuit 440 is electrically connected to the first sensor 420 and the second sensor 430. The sensing circuit 440 determines the presence or absence of an obstruction 450, such as a wafer or a cassette indexer, positioned immediately ahead of the wafer holder 400. The sensing circuit 440 includes a first signal line 442, a second signal line 444 and a controller 446. The signal lines 442, 444 transmit signals from the sensors 420, 430 to the controller 446. The controller 446 controls the motion of the wafer holder 400 according to the signals from the sensors 420, 430. The controller 446 is adapted for outputting a signal to stop the motion of the wafer holder 400 when the obstruction 450 is detected. For instance, the second sensor 430 serving as a receiver does not receive a light sent out from the first sensor 420 serving as a transmitter when the obstruction 450 is positioned between the first sensor 420 and the second sensor 430. In addition, the controller 446 can sound an alarm when the obstruction 450 is detected.

The Third Embodiment

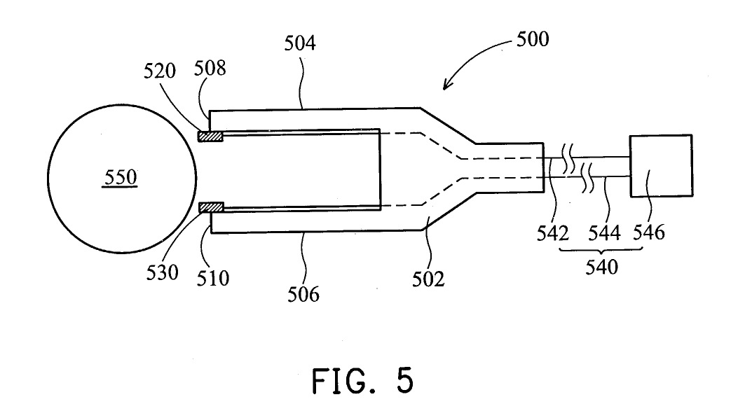

A wafer holder of the third embodiment is shown with reference to FIG. 5. FIG. 5 is a top view of the wafer holder according to the third embodiment of the present invention.

In FIG. 5, the wafer holder 500 in a robot blade assembly for transporting a wafer into and out of a process machine or a cassette indexer is provided. A holder plate 502 has a first extended finger 504 and a second extended finger 506. That is, the holder plate 502 is a twin finger plate. The first finger 504 has a first front end 508, and the second finger 506 has a second front end 510. The holder plate 502 can be constructed of a thin piece of metal.

In FIG. 5, a first sensor 520 is disposed at the first front end 508 of the first finger 504. A second sensor 530 is disposed at the second front end 510 of the second finger 506. The sensors 520, 530 can be optical sensors, such as the optical fiber sensor Model: PS-48 made by KEYENCE.

In FIG. 5, a sensing circuit 540 is electrically connected to the first sensor 520 and the second sensor 530. The sensing circuit 540 determines the presence or absence of an obstruction 550, such as a wafer or a cassette indexer, positioned immediately ahead of the first front end 508 and/or the second front end 510. The sensing circuit 540 includes a first signal line 542, a second signal line 544 and a controller 546. The signal lines 542, 544 transmit signals from the sensors 520, 530 to the controller 546. The controller 546 controls the motion of the wafer holder 500 according to the signals from the first sensor 520 and/or the second sensor 530. The controller 546 is adapted for outputting a signal to stop the motion of the wafer holder 500 when the obstruction 550 is detected by the first sensor 520 and/or the second sensor 530. In addition, the controller 546 can sound an alarm when the obstruction 550 is detected.

Thus, the present invention utilizes the sensor(s) disposed at the front end(s) of the wafer holder, thereby preventing system crash and shutdown during semiconductor manufacturing process and ameliorating the disadvantages of the prior art.

Finally, while the invention has been described by way of example and in terms of the above, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A wafer holder, comprising:
a holder plate having a front end;
at least one sensor disposed at the front end of the holder plate; and
a sensing circuit connected the sensor, wherein the sensing circuit determines the presence or absence of an obstruction positioned immediately ahead of the holder plate.

2. A wafer holder according to claim 1, wherein the sensing circuit further comprises:
a controller for controlling the motion of the wafer holder;
wherein the controller is adapted for outputting a signal to stop the motion of the wafer holder when an obstruction is detected.

3. The wafer holder according to claim 2, wherein the controller sounds an alarm when an obstruction is detected.

4. The wafer holder according to claim 1, wherein the sensor is an optical sensor.

5. A wafer holder, comprising:
a holder plate having a first extended finger and a second extended finger, wherein the first finger has a first front end, and the second finger has a second front end;
a first sensor disposed at the first front end of the first finger;
a second sensor disposed at the second front end of the second finger; and
a sensing circuit connecting the first sensor and the second sensor, wherein the sensing circuit determines the presence or absence of an obstruction positioned immediately ahead of the holder plate.

6. The wafer holder according to claim 5, wherein the sensing circuit further comprises:
a controller for controlling the motion of the wafer holder;
wherein the controller is adapted for outputting a signal to stop the motion of the wafer holder when an obstruction is detected.

7. The wafer holder according to claim 6, wherein the controller sounds an alarm when an obstruction is detected.

8. The wafer holder according to claim 5, wherein the first sensor is an optical sensor.

9. The wafer holder according to claim 5, wherein the second sensor is an optical sensor.
